(19) United States
(12) Patent Application Publication
(10) Pub. No.: US 2015/0016305 A1
(43) Pub. Date: Jan. 15, 2015

(54) METHODS AND SYSTEMS FOR NETWORK CONFIGURATION

(71) Applicant: IKAN HOLDINGS LLC, New York, NY (US)

(72) Inventors: Sion Elie Douer, New York, NY (US); William Priesler Adam, Sandy Hook, CT (US)

(21) Appl. No.: 14/505,078

(22) Filed: Oct. 2, 2014

Related U.S. Application Data
(63) Continuation-in-part of application No. 13/912,555, filed on Jun. 7, 2013, now Pat. No. 8,864,032.
Application No. 13/912,555 is a continuation of application No. 13/303,577, filed on Nov. 23, 2011, now Pat. No. 8,464,953.
Application No. 13/303,577 is a continuation of application No. 12/982,445, filed on Dec. 30, 2010, now Pat. No. 8,066,187.
Application No. 12/982,445 is a continuation of application No. 11/934,573, filed on Nov. 2, 2007, now Pat. No. 7,861,933.
(60) Provisional application No. 60/856,993, filed on Nov. 6, 2006.

(51) Int. Cl. H04W 48/16; H04W 84/12

(52) U.S. Cl. CPC H04W 48/16; H04W 84/12
USPC 370/254

(57) ABSTRACT

A configurable mobile system comprises a WiFi network interface and a wireless personal area network (WPAN) interface configured to communicate over a first type of WPAN. The system detects, via the WPAN interface, a presence of a beacon communicating over a WPAN of the first type and receives, from the beacon over the WPAN of the first type via the secure WPAN interface, network information for a local WiFi network. The system utilizes the network information received via the secure WPAN interface to configure network settings of the configurable mobile system with respect to the WiFi network interface to enable the configurable system to access the local WiFi network. The network information may including the network settings or may provide a link to such network settings.

### CROSS-REFERENCE TO RELATED APPLICATIONS

### Incorporation by Reference to any Priority Applications

Any and all applications for which a foreign or domestic priority claim is identified in the Application Data Sheet as filed with the present application, are hereby incorporated herein by reference in their entirety under 37 CFR 1.57.

### STATEMENT REGARDING FEDERALLY SPONSORED R&D

Not applicable.

### PARTIES OF JOINT RESEARCH AGREEMENT

Not applicable.

### REFERENCE TO SEQUENCE LISTING, TABLE, OR COMPUTER PROGRAM LISTING

Not applicable.

### BACKGROUND OF THE INVENTION

1. Field of the Invention

The present invention is related to electronic devices, and in particular, to methods and systems for configuring electronic devices.

2. Description of the Related Art

With the rapid increase in networkable consumer electronic systems, such as Internet radios, televisions with computer interfaces, and the like, there has been a rapid increase in consumer frustration regarding the configuration of such electronic systems so as to be able to access a network, such as the Internet.

For example, a conventional network configuration process (wherein the target network is the Internet), may involve accessing a network configuration user interface, entering the name of an Internet Service provider, specifying a network connection-type, specifying whether the connection is to be made via a broadband connection that needs a user name and password, via an “always-on” broadband connection that does not require a sign-in, or via a connection is to be made using a dial-up modem, specifying security related information, etc. Such a conventional process is difficult to perform on electronic devices having small screens not capable of displaying extensive user interfaces and/or having limited keyboards (e.g., that do not have an alphanumeric keyboard).

### SUMMARY

Example embodiments are described that enable configuration of device settings, such as a network interface, using a printed visual code read or accessed by the device.

An example embodiment provides a network configuration system, comprising a first user interface configured to receive from a user configuration information regarding a first network. The system further includes program code stored in computer readable memory configured to generate a barcode that includes information related to the first network configuration, where the barcode can be scanned by a device that has a barcode scanner that converts the barcode into digital data and the device uses at least a portion of the data to configure a network interface to access the first network.

An example embodiment provides a configuration system, comprising: a first user interface configured to receive from a user configuration information regarding a first device associated with the user; and program code stored in computer accessible memory configured to generate a visual code that includes information related to the first device configuration information, wherein the visual code can be read by the first device to configure, at least in part, the first device.

An example embodiment provides a method of providing network configuration information, comprising: causing at least in part a first user interface to be displayed to a user on a user terminal, the first user interface including fields for receiving configuration information for a first electronic device network interface; causing at least in part information provided by the user via the first user interface to be encoded in computer readable optical code, wherein the optical code can be read by the first electronic device using an optical image capture device; and causing at least in part the optical code to be displayed and/or printed via the user terminal, wherein the optical code is configured to be scanned to obtain the network interface configuration information.

An example embodiment provides a configurable system, comprising: a processor; memory coupled to the processor; a computer program stored in the memory that is executable by the processor; a network interface; and an optical reader, wherein the computer program is configured to utilize information read by the optical reader to configure network settings.

An example embodiment provides a method of configuring a system, comprising: causing, at least in part, an optical code to be read by the system using an optical reader that converts image information to digital data; and causing, at least in part, the digital data to be used to configure the operation of at least a network connection.

An example embodiment provides a method of configuring an electronic device, comprising: using an optical reader to read a visual code to obtain data encoded therein; and configuring a network connection of the electronic device using at least a portion of the data.

An aspect of the disclosure provides a configurable mobile system, comprising: a WiFi network interface; a secure wireless personal area network (WPAN) interface configured to communicate over a first type of WPAN; a computing system coupled to the WiFi network interface and the secure WPAN interface; non-transitory memory coupled to the computing device that stores program instructions configured to cause the computing system to perform operations comprising: detecting, via the secure WPAN interface, a presence of a beacon communicating over a WPAN of the first type; receiving, from the beacon over the WPAN of the first type via the secure WPAN interface, network information for a local WiFi network; utilizing the network information received via the secure WPAN interface to configure network settings of the configurable mobile system with respect to the WiFi network interface to enable the configurable system to access the local WiFi network without the user having to manually key in the network settings, wherein the network settings include at least: a local WiFi network identifier, and a local WiFi network password needed to communicate over the local WiFi network with other systems.

An aspect of the disclosure provides a configurable system, comprising: a first network interface (e.g., a WiFi network interface); a wireless personal area network (WPAN) interface configured to communicate over a first type of WPAN; a computing system coupled to the first network interface and the WPAN interface (which may optionally be a secure WPAN interface); non-transitory memory coupled to the computing device that stores program instructions configured to cause the computing system to perform operations comprising: detecting, via the secure WPAN interface, a presence of a beacon communicating over a WPAN of the first type; receiving, from the beacon over the WPAN of the first type via the WPAN interface, network information for a first network (e.g., a WiFi network); utilizing the network information received via the WPAN interface to configure network settings of the configurable system with respect to the first network interface to enable the configurable system to access the first network (e.g., without the user having to manually key in the network settings), wherein the network settings optionally include a first network identifier and/or a first network password needed to communicate over the first network with other systems.

An aspect of the disclosure provides a method of configuring a configurable mobile system, comprising: detecting, via a personal area network interface, a presence of a beacon communicating over a personal area network of a first type; receiving, from the beacon over the personal area network of the first type via the personal area network interface, network information for a local WiFi network; utilizing the network information received via the personal area network interface to configure network settings of the configurable mobile system with respect to the WiFi network interface to enable the configurable system to access the local WiFi network without the user having to manually key in the network settings, wherein the network settings include at least: a local WiFi network identifier, and a local WiFi network password needed to communicate over the local WiFi network with other systems.

An aspect of the disclosure provides a device, such as a beacon, comprising: a WiFi network interface; a secure wireless personal area network (WPAN) interface configured to communicate over a first type of WPAN; a computing system coupled to the WiFi network interface and the secure WPAN interface; non-transitory memory coupled to the computing device that stores program instructions configured to cause the computing system to perform operations comprising: detecting, via the secure WPAN, a presence of a configurable mobile system communicating over a WPAN of a first type; transmitting to the mobile configurable mobile system over the secure WPAN of the first type via the personal area network interface network information for a local WiFi network, the network information comprising a local WiFi network identifier and a local WiFi network password to enable the configurable mobile system to configure network settings of the configurable mobile system with respect to the WiFi network interface to enable the configurable mobile system to access the local WiFi network without the user having to manually key in the network settings, wherein the network settings include at least: the local WiFi network identifier, and the local WiFi network password needed to communicate over the local WiFi network with other systems.

An aspect of the disclosure provides a device, such as a beacon, comprising: a first network interface (e.g., a WiFi network interface); a wireless personal area network (WPAN) interface (which is optional secure) configured to communicate over a first type of WPAN; a computing system coupled to the first network interface and the WPAN interface; non-transitory memory coupled to the computing device that stores program instructions configured to cause the computing system to perform operations comprising: detecting, via the WPAN, a presence of a configurable mobile system communicating over a WPAN of a first type; transmitting to the mobile configurable mobile system over the WPAN of the first type via the personal area network interface network information for a first network (e.g., a WiFi network), the network information optionally comprising a local first network identifier and/or a local first network password to enable the configurable mobile system to configure network settings of the configurable mobile system with respect to the first network interface to enable the configurable mobile system to access the first network, wherein the network settings optionally include: the first network identifier, and/or the local first network password needed to communicate over local first network with other systems.

An aspect of the disclosure provides a method comprising: detecting, via a personal area network interface, a presence of a configurable mobile system communicating over a personal area network of a first type; transmitting to the mobile configurable mobile system over the personal area network of the first type via the personal area network interface network information for a local WiFi network to enable the configurable mobile system to configure network settings of the configurable mobile system with respect to the WiFi network interface to enable the configurable mobile system to access the local WiFi network without the user having to manually key in the network settings, wherein the network settings include at least: the local WiFi network identifier, and the local WiFi network password needed to communicate over the local WiFi network with other systems.

### BRIEF DESCRIPTION OF THE DRAWINGS

Embodiments of the present invention will now be described with reference to the drawings summarized below. These drawings and the associated description are provided to illustrate example embodiments of the invention, and not to limit the scope of the invention.

FIG. 1 illustrates an example configuration flow chart.

FIGS. 2A-C illustrate example user interfaces for receiving device settings.

FIGS. 3A-C illustrate example user interfaces displayed by a device being configured.

FIG. 3D illustrates an example optical code format.

FIG. 4 illustrates an example networked system,

FIG. 5 illustrates an example configurable electronic system.

FIGS. 6 and 7 illustrate example configuration processes.

### DETAILED DESCRIPTION OF PREFERRED EMBODIMENTS

Example systems and methods are described herein for configuring network settings on a device based on the characteristics of an available network and/or for setting user preferences for the device. Certain embodiments utilize visual indicia read by an optical reader to perform network configuration and/or to set user preferences for an electronic device.

As discussed above, certain conventional approaches for configuring an electronic device to access a network are overly complex for a typical consumer. Further, many conventional approaches rely on the device having a relatively large and expensive screen for displaying complex and detailed user interface, and having a relatively large keyboard (e.g., an alphanumeric keyboard) for entering in network configuration data. It would be advantageous to make it easier for a consumer to configure a consumer electronic device and to reduce the hardware requirements of the electronic device.

As discussed below, certain embodiments encode network configuration information and/or user preferences for an electronic device in an optical/visual code (e.g., a barcode) and utilize an optical reader, such as a barcode scanner, coupled to the electronic device to read the optical code. The electronic device then performs the network configuration and/or configures other device settings in accordance with the user preferences.

Throughout the following description, the term “Web site” is used to refer to a user-accessible network site that implements the basic World Wide Web standards for the coding and transmission of hypertextual documents. These standards currently include HTML (the Hypertext Markup Language), HTTP (the Hypertext Transfer Protocol), Java, and XML. It should be understood that the term “site” is not intended to imply a single geographic location, as a Web or other network site can, for example, comprise multiple geographically distributed computer systems that are appropriately linked together.

Furthermore, while the following description relates to an embodiment utilizing the Internet and related protocols, other networks and other protocols may be used as well. In addition, unless otherwise indicated, the functions described herein may be performed by executable code and instructions running on one or more general-purpose computers. For example, program code stored in non-volatile and/or volatile memory can include one or more instructions, which can optionally be straight-line code and/or organized as modules or objects configured to receive and process inputs, provide outputs, and to selectively store data. However, the present invention can also be implemented using special purpose computers, state machines, and/or hardwired electronic circuits. While certain example processes are described herein, not all the process states need to be performed, and the order of the process can be varied.

While certain example embodiments are described with reference to barcodes (e.g., linear barcodes, stacked barcodes, matrix barcodes, etc.) and barcode scanners, other computer readable indicia (e.g., dots, concentric circles, text codes hidden within images, text readable using optical character recognition systems, etc.) and scanners/image capture devices can be used. For example, a scanner/image capture device can be a laser scanner (e.g., including light source, a lens and a photo conductor translating optical impulses into electrical ones), a still frame camera, a video capture device, etc. While certain types of networks may be referred to (e.g., an IEEE 802.11 wireless network) other networks may be utilized (e.g., cellular networks, IEEE 802.16 networks, etc.). While the illustrated user interfaces may user certain language and provide certain user instructions, other language and instructions may be used.

In an example embodiment, a networked user terminal (e.g., a personal computer, an interactive television, a smart phone, a personal digital assistant, a networked-enabled digital music/video player, etc.) scans for existing wireless networks (or otherwise accesses information regarding local networks) and displays (e.g., via a computer system display) a listing of available networks (e.g., one or more IEEE 802.11 wireless networks) to the user. By way of example, a WiFi scanner can be used to discover wireless nodes (e.g., access point and wireless clients). The user chooses (e.g., by clicking on a network entry in the network listing) which network the user wants to configure a second device to access. By way of example, the second device has a barcode or other optical scanner. By way of further example, the second device can be a processor-based terminal, including a display, a keyboard, memory, a wired and/or wireless network interface, and a scanner/camera.

Optionally, the second device can be configured to be used to scan product information, such as that encoded in barcodes on household or business consumable items, such as food packaging. By way of further example, the second device can be a kitchen appliance (e.g., an oven, refrigerator, blender, television, computer, a waste receptacle, etc.) including or coupled to an optical scanner and including a network interface.

A user interface is provided that enables a user to input/select certain network information (e.g., what network the second device is to use, what is the security method being used, such as WEP, a network password, a network address, a proxy setting, etc.). Some or all of the information may be prepopulated based on information stored on or accessed by the computer system. The user interface may be provided by an application stored on the user's computer system or may be accessed over a network from a remote server (e.g., over the Internet, wherein the user interface is provided as a Web page or pages by a Web page server).

Additionally, a user interface is optionally provided via which a user can input device preferences, such as energy management settings (e.g., when or after what period of non-use the second device is to power down or enter a lower power consumption mode, such as by turning off the second device display until the user presses a button or otherwise uses the second device), display brightness, display contrast, and/or other preferences. The input/selected information can be stored locally in memory on the user computer system and/or remotely or a remote computer system (e.g., the computer system that provided the user interface).

Based on the selected/input information (e.g., configuration settings and/or preferences), the barcode generation application generates barcodes or other computer readable indicia/codes which can be printed (e.g., by a printer connected to the user computer system) in response to a user instruction or otherwise. The printed barcode(s) are then placed beneath or otherwise positioned with respect to the second device scanner, which then scans the code. The second device then configures its network setting and/or preference settings in accordance with the scanned code.

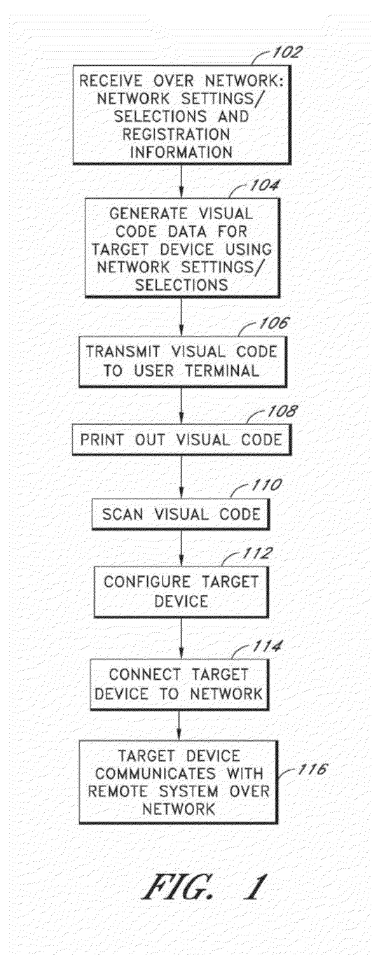

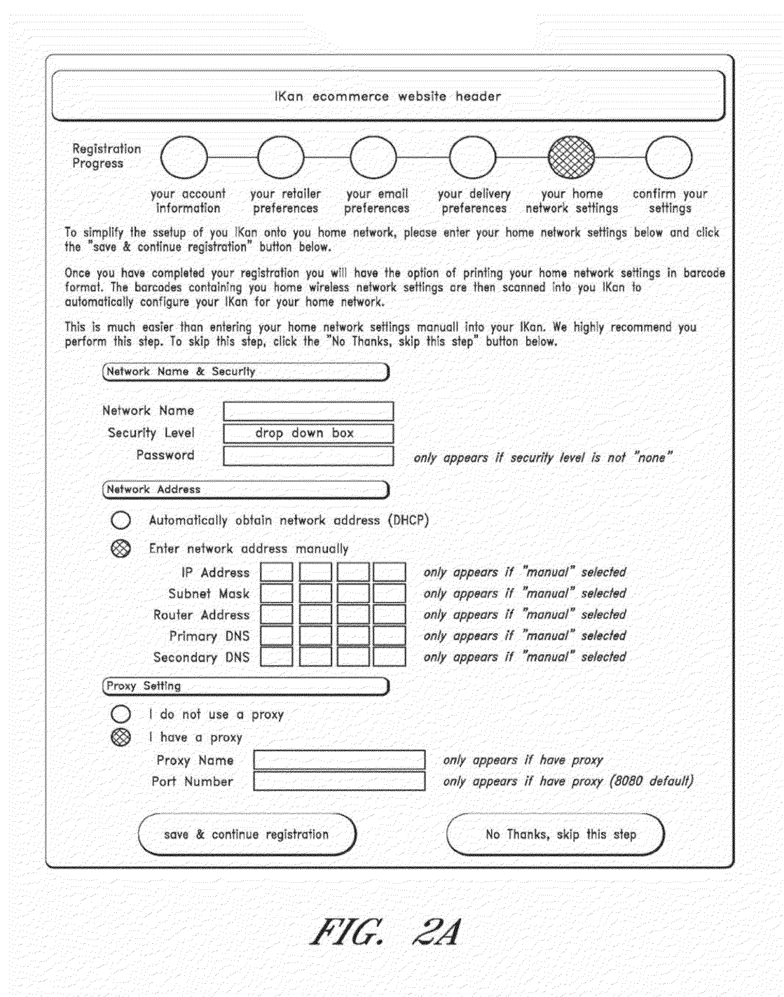

FIG. 1 illustrates an example configuration process for a target electronic device, (e.g., the scanning system described in U.S. Pat. No. 7,165,721, incorporated herein by reference, or other electronic device). The target device optionally has a relatively small display (e.g., less than 10 inches diagonal), and may have a relatively small keyboard (e.g., 9 keys or less, 5 keys or less, etc.). Optionally instead, the target device has a relatively large display and a relatively large keyboard. At state 102, a user accesses a website hosted by a remote system (e.g., an electronic commerce system, such as one that tracks user consumption of items and processes item orders received over a network or otherwise) via a terminal (e.g., a personal computer) coupled to a website. The terminal may be equipped with a relatively large display (e.g., 10 inches or more diagonally) and may be further equipped with an alphanumeric keyboard.

The user then proceeds to register to create an account (or if the user already has an account, the user can log in to edit/modify account information). For example, the user may be asked to provide a user name, contact information (e.g., email, physical address, phone number, etc.), identification information regarding the device to be configured (e.g., a part number and/or a serial number), payment information (e.g., a credit card number, a debit card number, etc.), and/or other information. In addition, the user may be asked to provide user preference information.

For example, if the target electronic device is intended to collect information regarding items consumed by the user and to generate shopping lists for replacement items, the user may be asked to specify user preferences related to how often to reorder items, who orders are to be placed with (e.g., which retailer/supermarket), how items are to be delivered, when items are to be delivered, what types of status notifications are to be automatically provided to the user, etc. Other example user preferences are described in U.S. Pat. No. 7,165,721.

Optionally, a user interface is provided via which the user can specify device settings. For example, the user can specify when (e.g., how long after the last use of the device) the device should enter a low power consumption mode (e.g., turn off display backlighting, let device hard drive spin down, turn off network radio, etc.). The information provided by the user at state 102 is stored in a user database or other data store.

In addition, a user is requested to provide/select network settings via a network configuration user interface. For example, the user may be asked to provide (by typing in, selecting from a menu, or otherwise) some or all of the following and/or other information:

Network name;

Network security level;

Password (if the security level necessitates a password);

Network address (e.g., IP address, subnet mask, router, DNS primary, DNS secondary, or an indication that the system is to automatically obtain the network address);

Proxy name and port number (if a proxy is being used).

When the user has provided the network configuration data, the user can select a “save” control and the data is stored locally on the user terminal and/or in the user database.

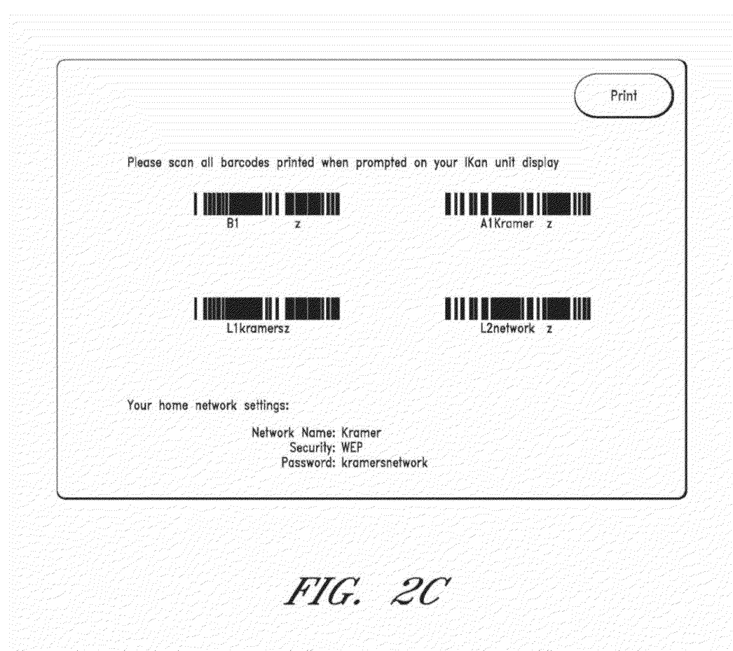

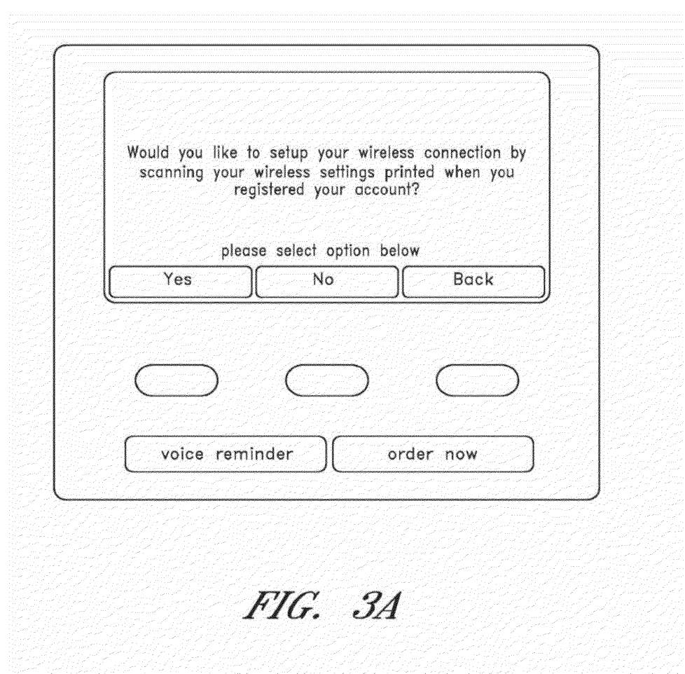

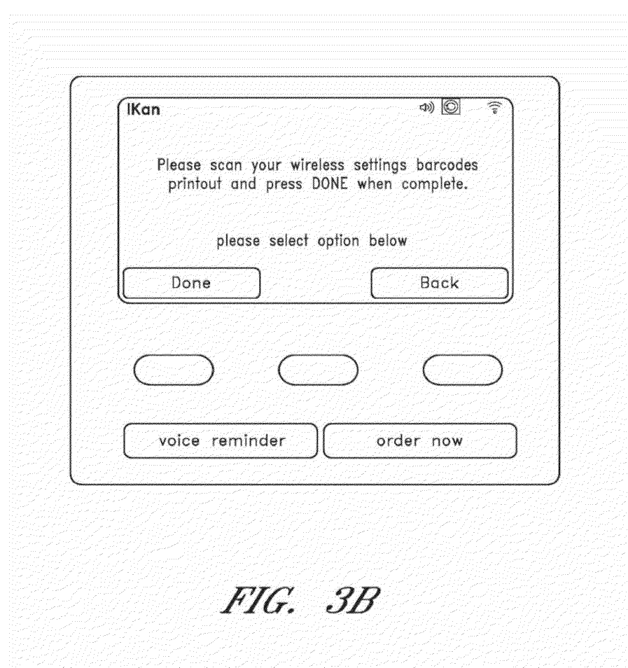

At state 104, the remote system (or the terminal) encodes the network configuration information using a barcode generator and preferences related to the electronic device into an optical code (e.g., a barcode). For example, the network name, security level, password, IP address, subnet mask, router, DNS, Proxy name, proxy port number can be encoded into a barcode, as illustrated in FIG. 3D.

Optionally, the system can encode other types of information into the barcode and/or additional barcodes. For example, the system can encode a Uniform Resource Locator (URL) or other locator which the device is to access and obtain information or programs. For example, the URL can access a Web site via which a new version of an operating system or program for the device can be downloaded to and installed by the device. By way of further example, the URL can access a site via which an item catalog or catalog data (or other database) can be downloaded.

At state 106, the remote system transmits the optical code in digital form (e.g., as a digital image or as data that can be converted by the terminal into an image) over the network to the user terminal. At state 108, the user prints out the optical code using a printer (e.g., a laser printer, an ink jet printer, a thermal printer, a sublimation printer, etc.) coupled to the user terminal (optionally, the user can scan the code directly from the terminal display without printing out the optical code).

At state 110, the user scans the optical code (e.g., from the printed hardcopy version or from the terminal display) using an optical scanner coupled to the electronic device. The scanner translates the optical code to digital data which is then stored in device memory. The digital data is provided/accessed by a corresponding program hosted on the device. The corresponding program then utilizes the digital data appropriately. For example, at state 112, a network configuration program accesses the network configuration portion of the data and configures the network interface accordingly. At state 114, the device connects to a network. At state 116, the device communicates with the system.

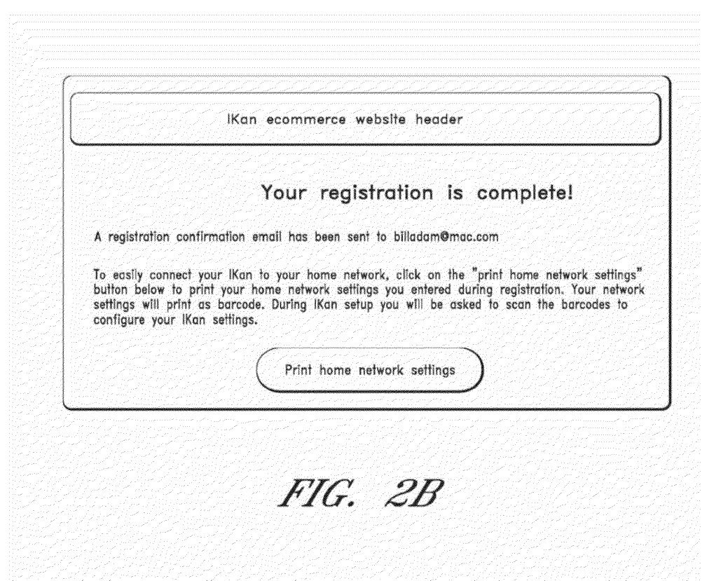

Certain example user interfaces with now be described with reference to FIG. 2AC. FIG. 2A illustrates an example user interface that can be utilized by a user to provide network configuration information to the system. The user interface display instructions for the user regarding providing network settings via the user interface. Corresponding fields are provided to receive the network settings. In this example, the following fields are provided (although other fields can be provided as well):

Network name;

Security level;

Password;

Automatically obtain network address check box (to instruct the device to automatically obtain the network address using, in this example, Dynamic Host Configuration Protocol);

Manually enter network address checkbox (to enable the user to enter network address information);

Fields for receiving manually entered network address information (IP address field, Subnet Mask field, Router address, Primary DNS, Secondary DNS);

Proxy name field;

Proxy port address.

A control is provided via which the user can instruct the system to save the network configuration system information;

A control is provided via which the user can skip entering data via the illustrated user interface (e.g., when the user would rather perform network configuration directly on the target device).

FIG. 2B illustrates a user interface presented once the user has completed the registration process. The user interface further instructs the user to print out the barcodes corresponding to the network settings and to scan the barcodes via the target device.

FIG. 2C illustrates an example print out of the barcodes corresponding to the network configuration data. In addition to barcode data, human readable text is provided including, in this example, the network name, security level, and password specified by the user. Other user provided data can be textually provided as well. Instructions on the use of the barcode are also provided.

FIGS. 3A-C illustrate example user interfaces for adding the target device to the user's network that are presented on an example target device display. In this example, the device includes three buttons whose functions may change and whose current functions are described by text/labels presented via the device display. In addition two buttons of fixed function with fixed labels are provided (a voice reminder/memo button to initiate recording of a voice memo/shopping list, and “order now” button to cause a substantially immediate order to be placed for a pending shopping list).

Referring to FIG. 3A, the example user interface asks the user if the user would like to setup a wireless network connection by having the device scan the printed wireless settings. The programmable buttons function respectively as a “yes” input, a “no” input, and a “back” button (to return to a previous menu). If the user activates the “yes” button, the example menu illustrated in FIG. 3B is presented. The user interface instructs the user to scan the wireless network setting barcodes printout and to press the “done” control when complete. One of the buttons is labeled “done” and another button is labeled “back”.

If the user activates the “done” button, once the device configures the network interface and successfully connects to a local network in accordance with the settings specified in the barcode, the example user interface displayed in FIG. 3C is presented on the device. The illustrated user interface informs the user that the device has successfully connected to the user's network and instructs the user to activate a control to begin using the networked device.

FIG. 3D illustrates an example barcode in code 128 barcode format and the relative position of the network setting information and of a calculated check digit. Code 128 is a linear symbology that encodes numbers, text functions and the 128 ASCII character set (from ASCII 0 to ASCII 128). A Code 128 barcode includes the following sections:

Quiet Zone;

Start Character;

Encoded Data;

Check Character;

Stop Character;

Quiet Zone.

The check character is calculated from a modulo 103 calculation of the weighted sum of all the characters.

Of course other barcode types can be used, including, without limitation: UPC, Code 25, Code 39, Code 93, Code 11, ITF-14, Codablock, Code 16K, PDF417, Aztec Code, bCode, Code 16K, PDF417, etc.

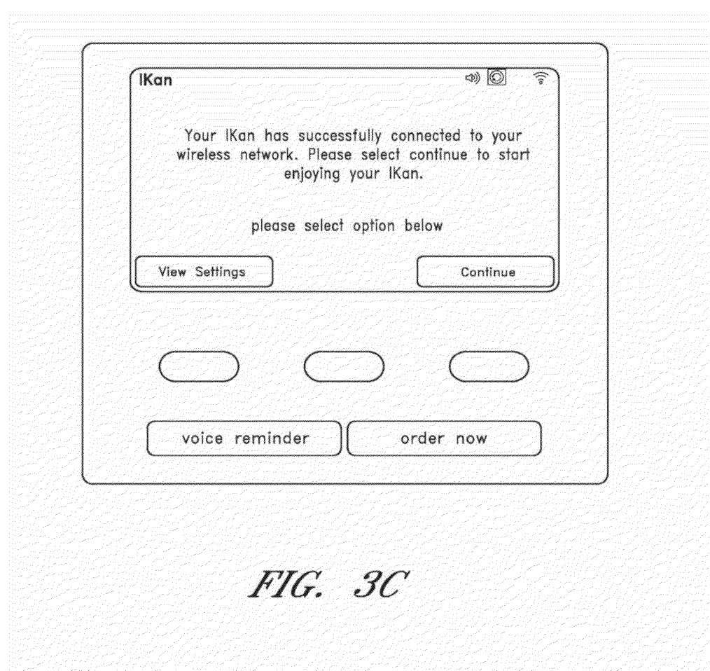

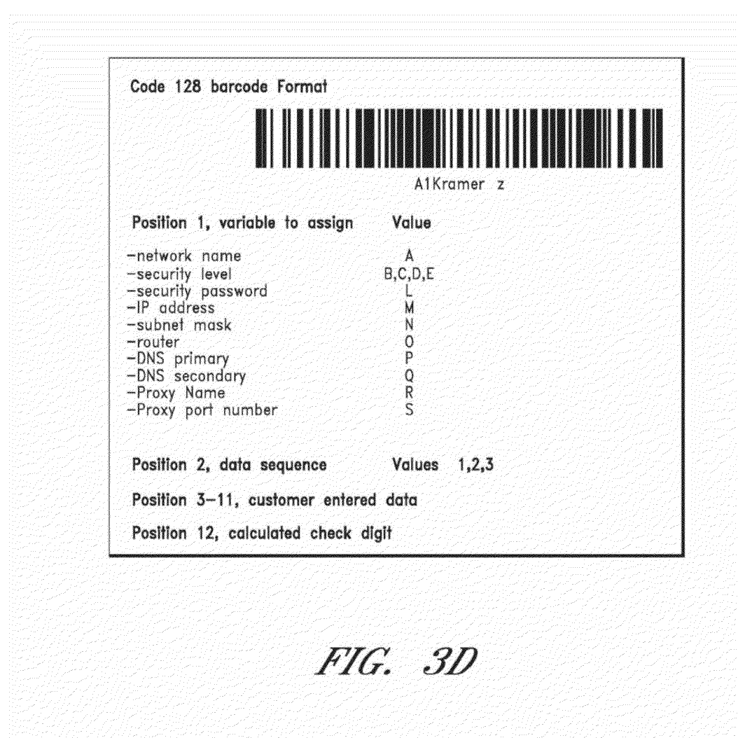

FIG. 4 illustrates an example networked configuration. In this example, a system 404, which may host an online commerce website (e.g., a shopping website) is coupled to a network 402 (the Internet in this example). The system 404 includes a Web server that hosts user interfaces for providing network settings, such as those described above with reference to FIGS. 2A-C. In addition, the system 404 in this example hosts a barcode generator that converts data provided by the user via the user interfaces (and optionally other data as well, such as Uniform Resource Locaters) into barcodes. The system can include a user database storing user registration information (e.g., user contact information, payment information, etc.), user preferences, target device identifiers, user specified network settings, barcode information, order histories, pending orders, electronic catalogs including item information (e.g., name, cost, type, etc.), and/or other information.

User terminals 406, 414 (in this example, personal computers associated with two different users and located in different locations), access the system 404 via the Internet 402. The terminals 406, 414 in this example include full keyboards (including a key for each letter and for the numbers 0-9, and well as keys for certain punctuations), displays, local memory (e.g., a hard disk drive and/or FLASH memory, RAM, etc.), and network interfaces (e.g., wired and/or wireless network interfaces). As similarly discussed above, the terminals 406, 414 can be used to access user interfaces, enter data, and receive communications provided by the system 404. The terminals 406, 414 may be equipped with browsers to access Web sites. For example, the terminals can display a barcode generated by the system 404 and provided via a webpage or via email. The terminals 406, 414 are connected to corresponding printers 408, 416, which can be used to print the barcodes.

Wireless network access points 412, 420 provide wireless the target devices access to an Internet connection.

Target devices 410 (a touch screen portable personal digital assistant in this example) and 418 (a video game system in this example) include or are coupled to optical scanners which can be used to scan the barcodes, as discussed above.

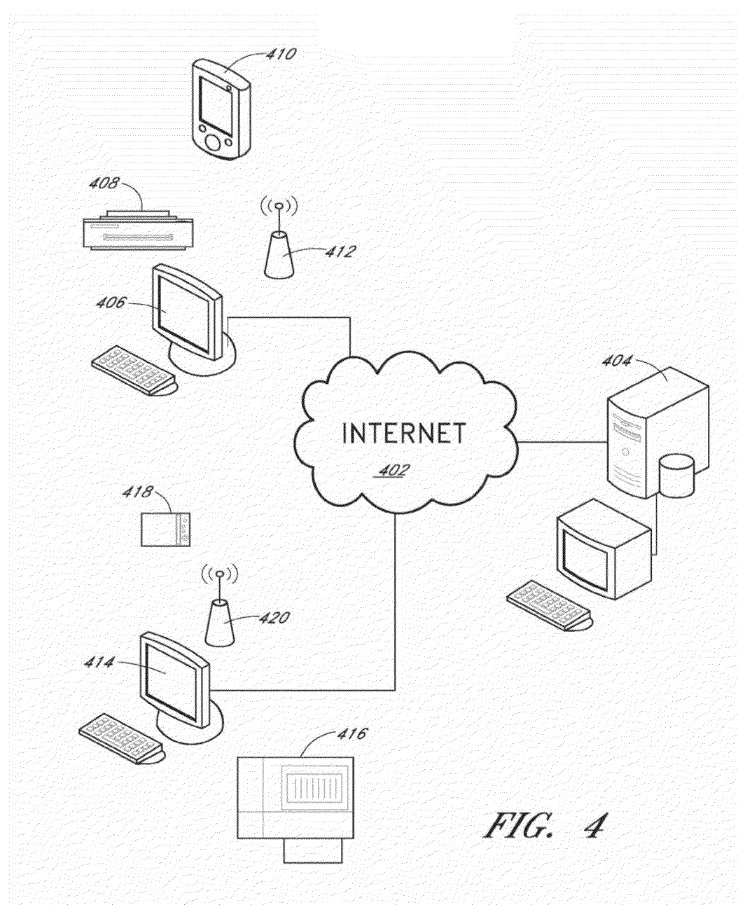

FIG. 5 illustrates another example target device. The device includes an integral barcode scanner 502, dedicated buttons 504, 506 (such as the fixed function buttons discussed above with respect to FIGS. 3A-C), programmable function buttons (such as the changeable function buttons discussed above with respect to FIGS. 3A-C), a display 512, and an antenna 514. The device may include a processor, memory (e.g., a magnetic disk, FLASH memory, and/or RAM), a wired and/or wireless network interface, and an interface to removable memory. The processor may be coupled to the memory, network interface(s), display, and buttons. The device memory may store programs, user interfaces and data, such as a product database. A program may be use optically read data (after being converted to digital data) to implement corresponding device settings (e.g., network settings, display settings, energy conservation settings).

Optionally, some or all of the Wi-Fi setup information (e.g., such as that described herein) may be communicated to the example target electronic device via a wireless personal area network (WPAN), such as Bluetooth®, NFC, ZigBee®, IrDA, and/or other network. Optionally, the Wi-Fi setup information may communicated via sound waves (e.g., in an audio stream), such as sound waves that are inaudible to humans (e.g., ultrasonic sound waves or subsonic sound waves at a frequency lower than 20 hz or higher than 20 khz) broadcast via a speaker and received at a target device (e.g., via a microphone). For example, the WiFi information may be encoded into an audio stream using amplitude modulation, frequency modulation, or otherwise Optionally, the WPAN is a secure network (e.g., using encryption, light of sight communication, and/or short range communication), making it difficult for third party devices to eavesdrop on communications with the target electronic device.

For example, Bluetooth® may be used to transmit data over short distances. Certain Bluetooth® standards use short-wavelength UHF radio waves in the ISM band (2.4 to 2.485 GHz). Bluetooth is a packet-based protocol using a master-slave arrangement were a given master may communicate with, and transmit data to slaves in a piconet, and where devices can, by agreement, switch roles, so that the slave can become the master.

There are several different versions of Bluetooth defining several security modes, where a given version supports a subset of all available modes. The security modes may differ with respect to at which point the Bluetooth device initiates security, which affects how well the security modes protect Bluetooth communications and devices from attacks.

For example, Bluetooth Basic Rate (BR), EDR, and HS, specify a security mode (Security Mode 3) that requires establishment of authentication and encryption before the Bluetooth physical link is completely established. Security Mode 4 (which is the default mode for Bluetooth 2.1+EDR and later devices) may also use authentication and encryption, but do not initiate them until after the Bluetooth physical link has already been fully established and logical channels partially established. Thus, Security Mode 3, when available, may be preferred for security purposes as compared to Security Mode 4.

Bluetooth LE (low energy), among other security modes, specifies Security Mode 1 Level 3 which requires authenticated pairing and encryption. Some security modes/levels permit unauthenticated pairing, with no man-in-the-middle protection provided during cryptographic key establishment, and certain modes do not require any security. Bluetooth LE typically has a range of 10 meters, but may have a range of up to 60 meters and possible more.

NFC also enables short-range (e.g., 10 cm or less) two-way communication between devices. NFC operates at 13.56 MHz on ISO/IEC 18000-3 air interface and at rates ranging from 106 kbit/s to 424 kbit/s. NFC may be used to communicate in a peer-to-peer mode, if both devices are powered. NFC typically uses magnetic induction between two loop antennas located within each device's near field. Applications may use higher-layer cryptographic protocols (e.g., SSL) to establish a secure channel between devices. Certain implementations of NFC enable communication to be initiated between devices by tapping one device (e.g., a phone to table computer) against another device (e.g., a stationary NFC terminal). Because NFC is short range, the range itself offers a level of physical security.

IrDA defines a set of protocols for wireless infrared communications. Advantageously, IrDA provides for physically secure, line of sight data transfer.

Thus, for example, a first device (e.g., a beacon, a WPAN hub, a base station, a personal computer, an interactive television, a smart phone, a personal digital assistant, a networked-enabled digital music/video player, etc.) may store internally or access (e.g., via a website accessed over the Internet) some or all of the following WiFi network information for a local WiFi network (e.g., a WiFi network accessible at least where the WPAN network is available, such as within a facility):

Network name/identifier;

Network security level;

Password;

Network address (e.g., IP address, subnet mask, router, DNS primary, DNS secondary, or an indication that the system is to automatically obtain the network address);

Proxy name and port number (if a proxy is being used).

In an example communication process, the first device may be equipped with one or more WPAN interfaces (e.g., Bluetooth, NFC, ZigBee, IrDA or other light emitting interface, sonic interface (e.g., generating inaudible sound signals, which may optionally be encrypted), etc.) which may be used to communicate with one or more target electronic devices having corresponding interfaces (e.g., Bluetooth, NFC, ZigBee, IrDA or other light emitting interface, sonic interface/microphone, etc.). Thus, for example, the first device may optionally include a WPAN hub enabling the first device to communicate with one device at a time or more than one target device at a time and optionally over one or more types of WPAN interfaces (e.g., Bluetooth, NFC, and/or sonic interfaces (to enable it to communicate with target devices that have a microphone) to enable it to communicate with target devices that have either a Bluetooth or NFC interface). A target electronic device (e.g., the scanning system described in U.S. Pat. No. 7,165,721, incorporated herein by reference in its entirety, or other electronic device, such as a mobile telephone, tablet computer, camera, health sensor, electronic appliance, etc.), may include a WiFi interface (or other WLAN) and one or more WPAN interfaces (e.g., Bluetooth, NFC, ZigBee, IrDA or other light emitting interface, sonic interfaces, (e.g., a microphone and corresponding hardware/software), etc.).

The target electronic device may include an application (e.g., a mobile device app) which may access the services offered by the target electronic device's WPAN interface (e.g., via a framework that abstracts low-level details from the corresponding WPAN specification). For example, the framework may enable the application to discover and connect, via the WPAN interface, with another device (e.g., the first device, such as a beacon) and to access and receive data from the other device. The framework may enable the application to cause the target electronic device to act as a central device or a peripheral device. The application may be associated with a place of commerce, such as a retail chain or a restaurant. In addition to providing network connectivity functionality, the application may optionally be configured to provide other functionality, such as enabling payments to be made to the retail establishment, enabling the target electronic device to receive and display retail establishment coupons and/or notifications of sales, and/or to provide other functionality.

If the application on the target electronic device is active/executing (e.g., opened by the user or triggered by detection of a code transmitted by the first device over the WPAN so that a user interface is presented to the user via the target electronic device) when in communication proximity of the first device, a communication channel may be established between the two in accordance with the WPAN protocol. The first device transmits to the target electronic device, via the WPAN (optionally using an encrypted or otherwise secure channel), some or all of the WiFi network information needed to connect to and utilize the local WiFi network. The application hosted by the target electronic device receives the WiFi network information, decrypts the received information (if needed), and then programs (e.g., using a WiFi settings API) the settings of the target electronic device's WiFi interface using such WiFi network information (e.g., network name/identifier and password). Optionally, the WiFi network information may be encoded using a barcode encoding format, such as those discussed elsewhere herein.

It should be noted that while the description herein may refer to an application (e.g., which may be downloaded from an application store), it is understood that the functionality described herein may be implemented in hardware or a combination of hardware and software.

The target electronic device may then use some or all of the WiFi network information (e.g., network name/identifier and password) to access and communicate over the local WiFi (or other corresponding WLAN) network. For example, the target device may use the local WiFi network to access local sites and/or to access other websites over the Internet.

By way of illustration, the foregoing technology may optionally be utilized in a place of commerce, such as a retail store, a restaurant, a mall, or other location or facility. For example, a place of commerce may offer its customers a local WiFi network which can be used to access a local site of the place of commerce (e.g., a store site) or be generally used to access websites over the Internet. However, the place of commerce may not want people outside of its facility (non-customers) to access the local WiFi network. Techniques described herein enable WiFi network information needed to access the local WiFi network to be passed to customer devices using a short range WPAN, thereby preventing or inhibiting devices outside of the facility from accessing the facility's local WiFi network. Thus, the use of WPAN provides a form of geofencing with respect to providing access to the place of commerce's WiFi network.

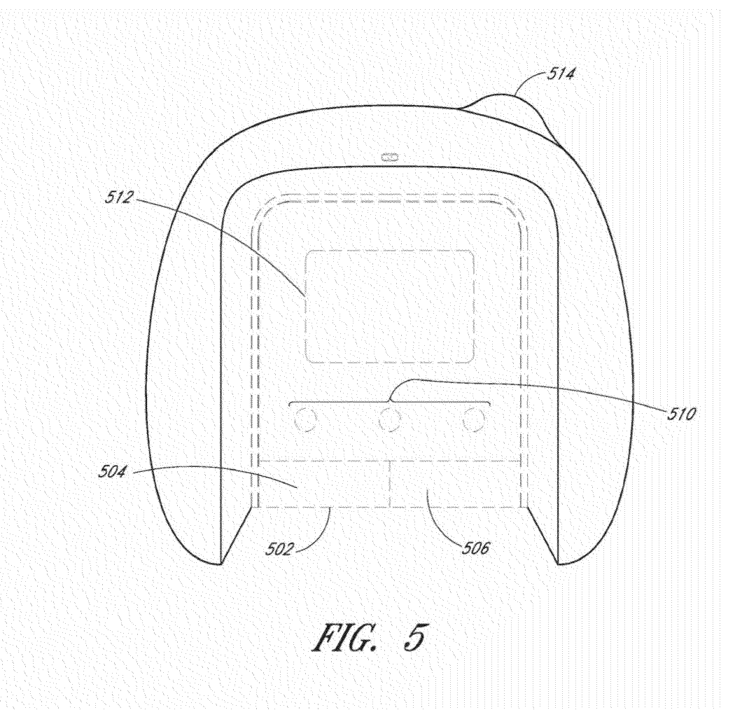

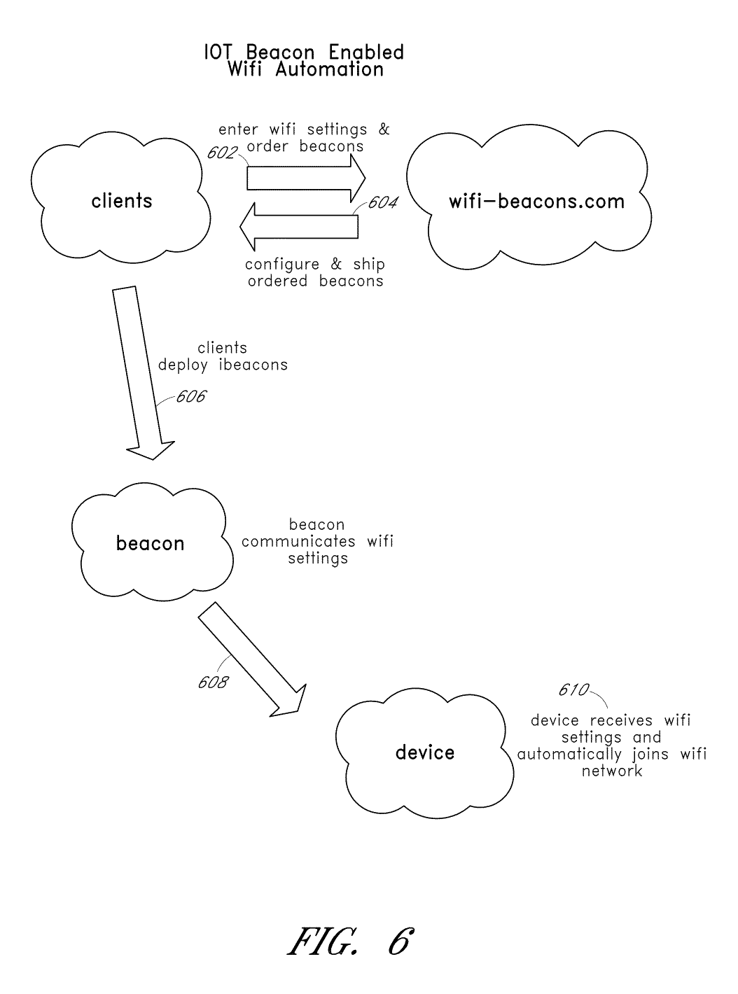

FIG. 6 illustrates an example process for enabling a target electronic device to receive WiFi network information for a local WiFi network, to thereby enable the target electronic device to access the local WiFi network. In this process, the first device optionally may not have an integrated keyboard and may not include a touch screen or any screen. The first device may or may not include indicators (e.g., LED lights), such as indicator lights that indicate whether the first device is powered on, the state of the first device's battery charge, whether the first device is coupled to a WiFi and/or WPAN network, etc. For example, optionally the first device may be a relatively low cost beacon, small enough to be affixed (e.g., via double sided tape, nails, screws, snaps, or otherwise) to a wall, display case, counter, etc. The beacon may optionally use a low power WPAN (e.g., low energy Bluetooth or NFC) and may be battery powered (e.g., via a rechargeable or non-rechargeable battery) or may be line powered. The beacon may be configured to transmit data, messages, and/or prompts directly to an electronic device (e.g., a mobile phone or tablet). Optionally, the beacon may include a light-emitting output device (e.g., a display,

LED emitter, etc.) configured to optically transmit the WiFi information (e.g., an optical barcode as discussed above). Optionally, the beacon may include a sound-emitting output device (e.g., a speaker or other transducer) configured to use sound waves to transmit the WiFi information. In addition to providing WiFi network information, the beacon may optionally be configured to provide customers with product information, coupons, information on sales, and/or to facilitate contactless payment. While the following description may refer to a beacon, it is understood that other devices, such as those discussed above, may be used.

As similarly discussed above, the target electronic device may be equipped with a WPAN interface and a WiFi interface. The target electronic device may be equipped with an application, such as an application downloaded from an application store or which may be preinstalled on the target device. The application may be associated with a place of commerce, such as a retail chain or a restaurant (e.g., the application may be provided by the retail establishment via an application store). In addition to providing network connectivity functionality, the application may optionally be configured to enable payments to be made to the retail establishment, to receive and display coupons, to receive notifications of sales, and/or provide other functionality.

At state 602, a client/business (e.g., which has a facility in which the beacon is to be placed and which will provide WiFi service within the facility) accesses a network resource, such as a website associated with a provider of the beacon, using a client terminal (e.g., a personal computer, an interactive television, a smart phone, a personal digital assistant, a networked-enabled digital music/video player, etc.). Thus, for example, the website may be operated by a manufacturer or distributor of the WPAN-equipped beacon, or a service provider associated with a manufacturer or distributor of the beacon. The client may enter some or all of the WiFi network information (e.g., network name/identifier, password, etc.) needed to access a local WiFi network of the client (e.g., offered at the client's facility), which will be received and stored by the website operator system. The client may also place an order for beacons to be programmed with some or all of the WiFi network information. Optionally, the client may enter different sets of WiFi network information for different sets of local WiFi networks of the client (e.g., for different client facilities or for different areas within a facility) and indicate the number of beacons that are to be programmed with a given set of WiFi network information (e.g., program 20 beacons with a first set of WiFi network information and program 40 beacons with a second set of WiFi network information). The order information may be stored by the website system, and the order may be processed.

At state 604, the beacons are programmed (e.g., by the beacon manufacturer, distributor, website operator, or other service provider) and shipped to the client in a programmed state. Optionally, the beacons may be marked (e.g., via an adhesive label, molding, imprinting, or otherwise) with the name or code associated with the WiFi network for which the beacon has been programmed to enable the client to identify in which facility (or area of a facility) the beacon is to be placed. At state 606, the client receives the beacons and places one or more of the beacons in the client's facility. For example, the client may place one or more beacons near the entrance of the facility (e.g., with 10 feet, within 20 feet, within 30 feet, within 40 feet of the entrance) so that user target devices may connect to the beacon substantially as soon as they walk into the facility. In addition or instead, the client may distribute one or more beacons near or on checkout counters, display cases, changing rooms, etc.

At state 608, a user enters the client's facility with a target device, such as a mobile phone, tablet computer or other device equipped with a corresponding WPAN, and a WiFi (or other applicable WLAN) interface, and a connection is established between a beacon and the target device (e.g., via the WPAN network). Optionally, the beacon transmits a signal to the target device which triggers and activates the application hosted by the target device. The beacon transmits the programmed WiFi network information for the local WiFi network to the target device. At state 610, the target device receives the WiFi network information, and the target device application automatically programs the WiFi settings of the target device (e.g., with the network identifier and password). The target device then automatically accesses the local WiFi network, and may access websites or other network accessible resources over the local WiFi network. Optionally instead, the user is prompted via the application to confirm that the user wants the user target device to join the local WiFi network prior to joining the local WiFi network. If the user indicates that the user does not want the user target device to join the local WiFi network, optionally the process terminates.

While the foregoing process utilizes a service to program the beacon, optionally, the client may program the WiFi network information directly into the beacon (e.g., using a WPAN-equipped programming device with a software development kit, a keyboard removably connectable to the beacon via a port (e.g., a USB port), or otherwise.

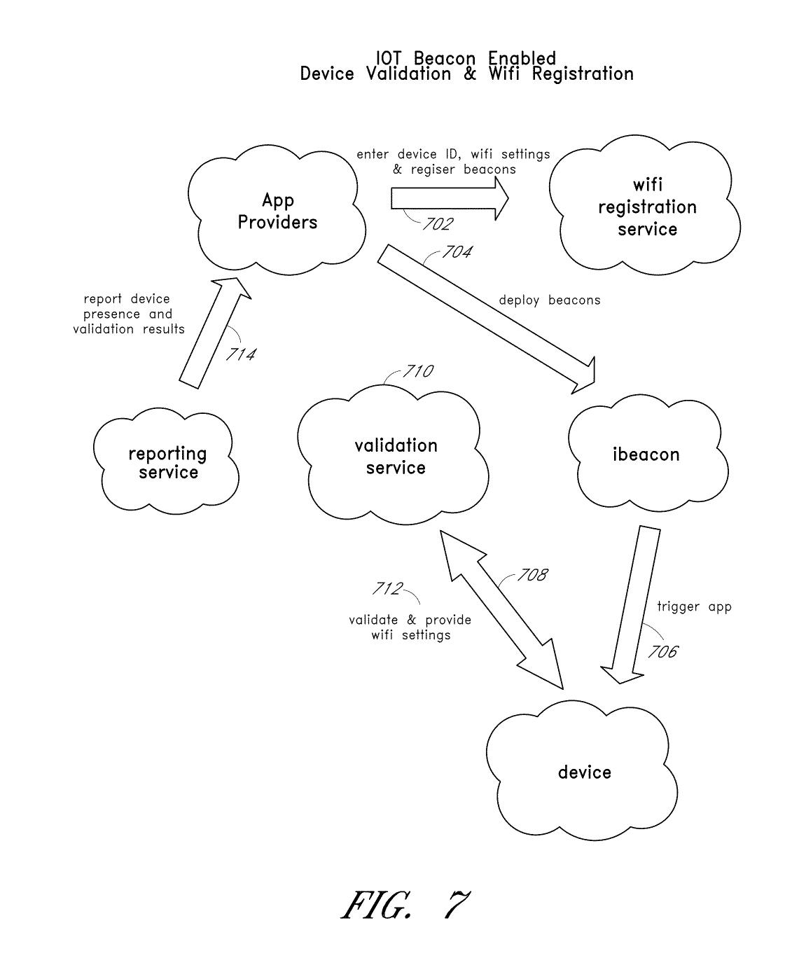

FIG. 7 illustrates another example process for enabling a target electronic device to receive WiFi network information for a local WiFi network, to thereby enable the target electronic device to access the local WiFi network. Optionally, this process utilizes a beacon having properties as similarly discussed above. In this example process, rather than the beacon providing the target device with the WiFi network information directly, the beacon may be configured to transmit a URL or other network resource locator to the target device, or the beacon may trigger the application to access a URL or other network resource locator preprogrammed into the application. The target device app may then access the WiFi network information from a website or other network resource associated with the URL or other locator, and use such information to access the local WiFi network.

At state 702, one or more beacons may be registered with a WiFi registration service (e.g., by a facility operator, beacon provider, or other client, where the client may be the provider of the application hosted on the user target device). For example, the beacon may be associated with an identifier, such as a unique serial number, printed on the beacon (e.g., on a sticker affixed to the beacon or otherwise). The beacon identifier and WiFi network information for the local WiFi (e.g., the network identifier, network password, and/or other information) may be provided by the entity registering the beacon. In addition, optionally the name or other identifier (e.g., a customer number) of the client (e.g., retail establishment, restaurant, other place of commerce, etc.) associated with the beacon is received and stored by the WiFi registration service. The registration information may be stored and access may be provided to a validation service which may in turn store the registration information.

A state 704, the facility operator may deploy one or more beacons within the facility (e.g., a retail establishment, restaurant, other place of commerce, etc.). At state 706 a user/customer of the facility enters the facility and comes within communication proximity of a facility beacon or other network device. The beacon or other network device triggers an application installed on the user's target device. As similarly discussed above, optionally the application may be associated with the client/facility operator, where the facility may be a retail establishment, restaurant, or other place of commerce. Optionally, in addition to providing network connectivity functionality, the application may be used to enable payments to be made to the retail establishment, to receive and display coupons, to receive notifications of sales, and/or provide other functionality. The beacon may transmit (e.g., using a WPAN) the beacon identifier and/or some of all of the WiFi network information to the target device and may optionally transmit a network resource locator associated with a validation service to the target device (or the network resource locator can be pre-programmed into the application). Optionally, the user is prompted via the application to confirm that the user wants the user target device to join the local WiFi network. If the user indicates that the user does not want the user target device to join the local WiFi network, optionally the process terminates.

At state 708, the target device application causes the target device to access a network resource (e.g., a website) associated with a validation service (e.g., using a mobile phone network, such as an LTE, GSM, CDMA, or using a local WiFi network for which only a short period of access time is granted (e.g., 1 minute, 5 minutes, or 10 minutes)). As noted above, the target device application may use a pre-preprogrammed network resource locator (e.g., a URL) or a network resource locator transmitted by the beacon. The target device transmits to the validation service system at least some of the information it had received from the beacon (e.g., the beacon identifier).

At state 710, the validation service system receives the beacon provided information from the target device (e.g., the beacon identifier), searches for the corresponding beacon record using a search engine, and locates the corresponding local WiFi network information. At state 712, the validation service transmits the network information for the local WiFi network to the target device using an encrypted or otherwise secure channel. The target device application receives and decrypts the network information (if needed), and may then automatically program (e.g., using a WiFi settings API) the settings of the target device's WiFi interface using such WiFi network information. The target electronic device may then use some or all of the WiFi network information (e.g., network identifier and password) to access and communicate over the local WiFi network (e.g., to access local sites and/or to access other websites over the Internet).

Optionally, in the foregoing processes, once it is detected that the user has left the facility (e.g., by the application failing to detect the local WiFi network or by the local WiFi network system or beacons detecting that the user target device is no longer in contact with the WiFi network or beacons), the user target device may be de-authorized for the local WiFi network and will need to repeat the network joining process. Optionally, the local network password may be changed periodically, at least during a facility's public operating hours (e.g., every 30 minutes, every 60 minutes, every day, etc.), and the target device application will periodically be triggered and will retrieve the new password as described above if the target device is still present in the facility (e.g., a detected via a beacon).

At state 714, the validation service, using a reporting service generates a report indicating which user target devices were detected at which facilities (and optionally, which area(s) of a given facility), the date/time the user target devices were detected (e.g., via the WPAN and/or WLAN), the date/time it is determined user target devices are no longer at the facility (via the WPAN and/or WLAN), and/or whether corresponding validations request were successful or unsuccessful. The report may be electronically or physically transmitted to the clients that operate the facilities and/or other designated recipients.

It is understood, that while the foregoing descriptions mentions certain wireless local area network types (e.g., Wi-Fi) other local area network types may be used. Further, while reference may be made to utilizing beacons in retail establishments by way of example, beacons may be similarly used in other locations, such as a home, park, cruise ship, or elsewhere.

Thus, described above are efficient methods and systems for performing device configuration, including network configuration, even when certain user interface devices (e.g., a large screen, a full keyboard) are lacking.

The methods and processes described herein may have fewer or additional steps or states and the steps or states may be performed in a different order. Not all steps or states need to be reached. The methods and processes described herein may be embodied in, and fully or partially automated via, software code modules executed by one or more general purpose computers. The code modules may be stored in any type of computer-readable medium or other computer storage device. Some or all of the methods may alternatively be embodied in whole or in part in specialized computer hardware. The results of the disclosed methods may be stored in any type of computer data repository, such as relational databases and flat file systems that use volatile and/or non-volatile memory (e.g., magnetic disk storage, optical storage, EEPROM and/or solid state RAM).

While the phrase “click” may be used with respect to a user selecting a control, menu selection, or the like, other user inputs may be used, such as voice commands, text entry, gestures, etc. User inputs may, by way of example, be provided via an interface, such as via text fields, wherein a user enters text, and/or via a menu selection (e.g., a drop down menu, a list or other arrangement via which the user can check via a check box or otherwise make a selection or selections, a group of individually selectable icons, etc.). When the user provides an input or activates a control, a corresponding computing system may perform the corresponding operation. Some or all of the data, inputs and instructions provided by a user may optionally be stored in a system data store (e.g., a database), from which the system may access, retrieve, and process such data, inputs, and instructions. The notifications and user interfaces described herein may be provided via a Web page, a dedicated or non-dedicated phone application, computer application, a short messaging service message (e.g., SMS, MMS, etc.), instant messaging, email, push notification, audibly, and/or otherwise. Optionally, user interfaces may be provided with editing tools, enabling users to select, cut, copy, paste, undo, redo, and otherwise edit user provided content and/or other content.

The user terminals (e.g., the target electronic devices) described herein may be in the form of a mobile communication device (e.g., a cell phone), laptop, tablet computer, interactive television, game console, media streaming device, head-wearable display, networked watch, etc.

Many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the invention can be practiced in many ways. As is also stated above, the use of particular terminology when describing certain features or aspects of certain embodiments should not be taken to imply that the terminology is being re-defined herein to be restricted to including any specific characteristics of the features or aspects of the invention with which that terminology is associated.

What is claimed is:

1. A configurable mobile system, comprising:
a WiFi network interface;
a secure wireless personal area network (WPAN) interface configured to communicate over a first type of WPAN;
a computing system coupled to the WiFi network interface and the secure WPAN interface;
non-transitory memory coupled to the computing system that stores program instructions configured to cause the computing system to perform operations comprising:
detecting, via the secure WPAN interface, a presence of a beacon communicating over a WPAN of the first type;
receiving, from the beacon over the WPAN of the first type via the secure WPAN interface, network information for a local WiFi network;
utilizing the network information received via the secure WPAN interface to configure network settings of the configurable mobile system with respect to the WiFi network interface to enable the configurable system to access the local WiFi network without the user having to manually key in the network settings,
wherein the network settings include at least:
a local WiFi network identifier, and
a local WiFi network password needed to communicate over the local WiFi network with other systems.

2. The configurable mobile system as defined in claim 1, wherein
the WPAN interface comprises a Bluetooth, a near field communication (NFC) an IrDa interface, and/or a sonic interface,
the configurable mobile system comprises a mobile phone and an application downloaded to the mobile phone, wherein the application is configured to cause the mobile phone to perform the operations comprising:
receiving, from the beacon over the WPAN of the first type via the secure WPAN interface, the network information for the local WiFi network;
utilizing the network information received via the secure WPAN interface to configure network settings of the configurable mobile system with respect to the WiFi network interface to enable the configurable mobile system to access the local WiFi network without the user having to manually key in the network settings.

3. The configurable mobile system as defined in claim 1, wherein the WPAN interface comprises a Bluetooth, a near field communication (NFC) an IrDa interface, and/or a sonic interface.

4. The configurable mobile system as defined in claim 1, wherein the network information comprises an address for a network resource used by the configurable mobile system to access at least the local WiFi network password.

5. The configurable mobile system as defined in claim 1, wherein the configurable mobile system comprises a mobile phone.

6. The configurable mobile system as defined in claim 1, wherein the configurable mobile system comprises a mobile phone and an application downloaded to the mobile phone, wherein the application is configured to cause the mobile phone to perform the operations comprising:
receiving, from the beacon over the WPAN of the first type via the secure WPAN interface, the network information for the local WiFi network;
utilizing the network information received via the secure WPAN interface to configure network settings of the configurable mobile system with respect to the WiFi network interface to enable the configurable mobile system to access the local WiFi network without the user having to manually key in the network settings.

7. The configurable mobile system as defined in claim 1, wherein the configurable mobile system comprises a mobile phone and an application downloaded to the mobile phone, wherein the application is configured to be triggered to be viewable by the user at least partly in response to a communication from the beacon.

8. A method of configuring a configurable mobile system, comprising:
detecting, via a personal area network interface, a presence of a beacon communicating over a personal area network of a first type;
receiving, from the beacon over the personal area network of the first type via the personal area network interface, network information for a local WiFi network;
utilizing the network information received via the personal area network interface to configure network settings of the configurable mobile system with respect to the WiFi network interface to enable the configurable system to access the local WiFi network without the user having to manually key in the network settings,
wherein the network settings include at least:
a local WiFi network identifier, and
a local WiFi network password needed to communicate over the local WiFi network with other systems.

9. The method as defined in claim 8, wherein
the personal area network interface comprises a Bluetooth, a near field communication (NFC) an IrDa interface, and/or a sonic interface,
the configurable mobile system comprises a mobile phone and an application downloaded to the mobile phone, wherein the application is configured to cause the mobile phone to perform the operations comprising:
receiving, from the beacon over the WPAN of the first type via the secure WPAN interface, the network information for the local WiFi network;
utilizing the network information received via the secure personal area network interface to configure network settings of the configurable mobile system with respect to the WiFi network interface to enable the configurable mobile system to access the local WiFi network without the user having to manually key in the network settings.

10. The method as defined in claim 8, wherein the personal area network interface comprises a Bluetooth, a near field communication (NFC), or an IrDa interface.

11. The method as defined in claim 8, wherein the network information comprises an address for a network resource used by the configurable mobile system to access at least the local WiFi network password.

12. The method as defined in claim 8, wherein the beacon is positioned in proximity of an entrance of a retail establishment.

13. The method as defined in claim 8, wherein the beacon stores the local WiFi network identifier and the local WiFi password in local memory, and wherein the network information comprises the local WiFi network identifier and the local WiFi password.

14. The method as defined in claim 8, wherein the configurable mobile system comprises a mobile phone.

15. The method as defined in claim 8, wherein the configurable mobile system comprises a mobile phone and an application downloaded to the mobile phone, the downloaded application configured to perform operations comprising
receiving, from the beacon over the personal area network of the first type via the personal area network interface, the network information for the local WiFi network;
utilizing the network information received via the personal area network interface to configure network settings of the configurable mobile system with respect to the WiFi network interface to enable the configurable mobile system to access the local WiFi network without the user having to manually key in the network settings.

16. The method as defined in claim 8, wherein the configurable mobile system comprises a mobile phone and an application downloaded to the mobile phone, the method further comprising causing the application to be triggered to be viewable by the user at least partly in response to a communication from the beacon.

17. A beacon, comprising:
a WiFi network interface;
a secure wireless personal area network (WPAN) interface configured to communicate over a first type of WPAN;
a computing system coupled to the WiFi network interface and the secure WPAN interface;
non-transitory memory coupled to the computing system that stores program instructions configured to cause the computing system to perform operations comprising:
detecting, via the secure WPAN, a presence of a configurable mobile system communicating over a WPAN of a first type;
transmitting to the mobile configurable mobile system over the secure WPAN of the first type via the personal area network interface network information for a local WiFi network, the network information comprising a local WiFi network identifier and a local WiFi network password to enable the configurable mobile system to configure network settings of the configurable mobile system with respect to the WiFi network interface to enable the configurable mobile system to access the local WiFi network without the user having to manually key in the network settings,
wherein the network settings include at least:
the local WiFi network identifier, and
the local WiFi network password needed to communicate over the local WiFi network with other systems.

18. The beacon as defined in claim 17, wherein the configurable mobile system comprises a mobile phone and an application downloaded to the mobile phone, wherein the application is configured to cause the mobile phone to perform the operations comprising:
receiving, from the beacon over the WPAN of the first the network information for the local WiFi network;
utilizing the received network information to configure network settings of the configurable mobile system with respect to the WiFi network interface to enable the configurable mobile system to access the local WiFi network without the user having to manually key in the network settings.

19. The beacon as defined in claim 17, wherein the network information comprises an address for a network resource used by the configurable mobile system to access at least the local WiFi network password.

20. The beacon as defined in claim 17, wherein the beacon stores the local WiFi network identifier and the local WiFi password in local memory, and wherein the network information comprises the local WiFi network identifier and the local WiFi password.

21. The beacon as defined in claim 17, wherein the network information comprises an address for a network resource used by the configurable mobile system to access at least the local WiFi network password.

22. The beacon as defined in claim 17, further comprising an adhesive configured to mount the beacon to a surface.

23. A method comprising:
detecting, via a personal area network interface, a presence of a configurable mobile system communicating over a personal area network of a first type;
transmitting to the mobile configurable mobile system over the personal area network of the first type via the personal area network interface network information for a local WiFi network, to enable the configurable mobile system to configure network settings of the configurable mobile system with respect to the WiFi network interface to enable the configurable mobile system to access the local WiFi network without the user having to manually key in the network settings,
wherein the network settings include at least:
the local WiFi network identifier, and
the local WiFi network password needed to communicate over the local WiFi network with other systems.

24. The method as defined in claim 23, wherein the configurable mobile system comprises a mobile phone and an application downloaded to the mobile phone, wherein the application is configured to cause the mobile phone to perform the operations comprising:
receiving, from the beacon over the personal area network of the first type the network information for the local WiFi network;
utilizing the network information received via the personal area network to configure network settings of the configurable mobile system with respect to the WiFi network interface to enable the configurable mobile system to access the local WiFi network without the user having to manually key in the network settings.

25. The method as defined in claim 23, the method further comprising deauthorizing the configurable mobile system to inhibit the configurable mobile system's ability to access the local WiFi network based at least in part on a determination that the configurable mobile system is not located in a first area.

26. The method as defined in claim 23, wherein the network information comprises an address for a network resource used by the configurable mobile system to access at least the local WiFi network password.

27. The method as defined in claim 23, wherein the beacon is positioned in proximity to an entrance of a retail establishment.

28. The method as defined in claim 23, wherein the beacon stores the local WiFi network identifier and the local WiFi password in local memory, and wherein the network information comprises the local WiFi network identifier and the local WiFi password.

29. The method as defined in claim 23, wherein the network information comprises an address for a network resource used by the configurable mobile system to access at least the local WiFi network password.

30. The method as defined in claim 23, the method further comprising affixing the beacon, using an adhesive, to a surface positioned in proximity with an entrance of a retail establishment.
